(19) United States
(12) Patent Application Publication
(10) Pub. No.: US 2019/0368839 A1
(43) Pub. Date: Dec. 5, 2019

(54) LONG GUN STABILIZATION APPARATUS FOR USE WITH HARD BODY ARMOR

(71) Applicant: SkeepDogKit, LLC, Evergreen, CO (US)

(72) Inventors: Kyle Schiedeman, Evergreen, CO (US); Benny Chi, Guilford, CT (US); Giovanni Meier, Madison, CT (US); Gintaras Vaisnys, Chicago, IL (US)

(73) Assignee: SheepDogKit, LLC, Evergreen, CO (US)

(21) Appl. No.: 15/995,674

(22) Filed: Jun. 1, 2018

(51) Int. Cl. F41C 33/00; F16M 13/04; F41C 23/20

(52) U.S. Cl. CPC F41C 33/001; F16M 13/04; F41H 1/02; F41C 33/007; F41C 33/003; F41C 23/20

(57) ABSTRACT

A long gun stabilization kit for use with a body armor vest, including a vest clip and a butt end portion. The vest clip includes a clip body and a ball, and has vest attachment means for attaching to the body armor vest. The vest clip is characterized by a vest interface plane having a normal, and the ball is connected to the clip body by a projection extending from the clip body at an angle that is downward, and left or right relative to the normal. The butt end portion has a socket shaped to receive the ball and permit rotation about at least one axis. Body armor may comprise a vest clip connected to a body armor vest. A long gun may have a barrel, and a stock having a butt end, a portion of the butt end having a socket of fixed geometry.

### FIELD

The present invention relates to long gun stabilization gear, and more particularly long gun stabilization gear for use with hard body armor.

### BACKGROUND

Tactical forces of the military and police commonly use long guns (including but not limited to rifles, carbines and shotguns) while wearing hard body armor (e.g., ceramic plates or steel plates) that are disposed in a body armor vest (also referred to herein simply as “a vest”). The use of a long gun with hard body armor and a vest significantly affects aspects of long gun operation (e.g., recoil management, positioning for discharge, and aligning a shooter's eye with the gun's sighting system (also referred to herein simply as a sight)).

While a shooter that is not using body armor typically rests the butt end of the long gun in the pocket formed by his/her firing shoulder (also referred to as the hollow of the shoulder) to comfortably and reliably position the long gun and thereby permit viewing along the gun's sight, body armor prevents or interferes with such positioning. Positioning the long gun on the vest in a manner as would be done when not using body armor tends to result in the long gun sliding along the armor (1) as the gun is positioned against the vest and (2) as a result of discharge of the long gun. In particular, sliding will occur during a sequence of discharges, where recoil from a first discharge causes the gun to shift and become unstable, and recoil from subsequent shots causes greater shifting and sliding. Further, the presence of the armor between the long gun and the shooter results in the shooter losing the tactile feedback that results from the long gun interfacing with a shooter's body.

Compounding the above problems, to permit a shooter who is wearing body armor to view along the long gun sight, the shooter commonly locates a mere corner of a butt end of a gun at a location near an edge of the body armor that is proximate the notch of the shoulder. Such positioning compromises reliable positioning of the long gun due to the fact that the butt end interfaces with the body armor over a small area, and may result in sliding of the long gun along the armor and even off the edge of the armor during positioning and discharge of the long gun.

Designers have proposed numerous solutions to achieving gun stability when used with body armor. As illustrated in United States Published Application No. 2009/0229160 and United States Published Application No. 2010/0107466, some have proposed use of a clamping structure to secure a vest containing body armor to a feature on the butt end of a rifle. Others (e.g., U.S. Pat. No. 8,215,045) have required a shooter to perform a two-step motion to secure the rifle within a receptacle that is disposed on a vest containing body armor. Each design has limitations, such as, requiring a time-consuming attachment technique, requiring a relatively complicated sequence of motions to achieve attachment and/or interfering with aiming of the rifle.

### SUMMARY

Aspects of the present invention are directed to a long gun stabilization device that provides management of recoil forces as well as simple engagement and disengagement of the stabilization device (e.g., engagement using motion in a single direction), ergonomic viewing along the sight for aiming, ability to align the long gun in a relatively large cone of discharge angles, and maintaining gun usability when not using body armor. Although aspects of the invention and prior art are described with reference to particular long gun types (e.g., rifles), it is to be understood that aspects of invention apply to all suitable long guns including, but not limited to, rifles, carbines and shotguns.

In accordance with one aspect of the present invention, there is provided a long gun stabilization kit for use with a body armor vest, the kit comprising a vest clip and a butt end portion. The vest clip comprises a clip body and a ball, and having vest attachment means for attaching to the body armor vest. The vest clip is characterized by a vest interface plane having a normal, the ball connected to the clip body by a projection extending from the clip body at an angle that is downward, and left or right relative to the normal. The butt end portion has a socket shaped to receive the ball and permit rotation about at least one axis.

In some embodiments, the butt end portion constitutes a portion of a butt stock.

In some embodiments, the ball may be spherical.

The vest attachment means may comprise an eyelet for receiving a shoulder strap of the body armor vest disposed at a top end of the clip body and at least two hooks at a bottom end of the clip body.

The clip body may be cuboid.

The clip body may be configured such that a front surface of the clip body is not parallel to a back surface of the clip body.

In some embodiment, the angle has a downward component in the range 20 and 30 degrees, and a left or right component in the range 15 and 25 degrees.

The butt end portion may constitute a portion of a butt stock attachment.

In some embodiments, the butt stock attachment comprises a lip configured to be positionable around an end plate of a butt end of a gun to maintain a connection with the butt end. In some embodiments, the butt stock attachment comprises a screw hole configured allow attachment of the butt stock attachment to a gun stock.

The butt end portion may constitute a portion of a butt stock. The butt end portion may be integrally formed with a remainder of a gun.

The socket may be spherical in shape. The butt end portion may have a guide having sides sloped to funnel objects into the socket.

Another aspect of the invention is directed to a vest clip for stabilizing a long gun, comprising a clip body and a ball, and having vest attachment means for attaching to a body armor vest. The vest clip is characterized by a vest interface plane having a normal. The ball is connected to the clip body by a projection extending from the clip body at an angle that is downward, and left or right relative to the normal.

Still another aspect of the invention is directed to body armor comprising a body armor vest, and a vest clip connected to the body armor vest. The vest clip comprises a clip body and a ball. The vest clip is characterized by a vest interface plane having a normal, the ball connected to the clip body by a projection extending from the clip body at an angle that is downward, and left or right relative to the normal.

In some embodiments, the body armor vest includes hard body armor positioned such that a force applied to the ball in direction of the clip body is resisted by the hard body armor.

Yet another aspect of the invention is directed to a butt attachment comprising a body of the butt end attachment having a socket of fixed geometry, and means for attaching the body to a long gun stock butt end.

Still another aspect of the invention is directed to a long gun, comprising a barrel, and a stock having a butt end, a portion of the butt end having a socket of fixed geometry.

Kit components such as a vest clip and a butt end portion may, for example, be made of any suitable material rigid and durable enough to withstand shock from gun discharges, such as a metallic material or rigid plastic (e.g., polycarbonate or a nylon). For example, the material may be Lexan® 243R or Lexan® 940-701 both available from SABIC Plastics of Saudi Arabia, or the material may be a Nylon 66 such as Zytel® 8018HS 14% Glass Fiber or Zytel® BKB08 Nylon or Zytel® ST801 Nylon or ST801AW all available from DowDupont, Inc. The components may be made using any suitable technique, for example, the components may be machined, molded or manufactured using additive manufacturing.

The term “ball” as used herein with reference to a ball of a ball and socket joint is not limited to a sphere and includes other shapes that approximate a sphere (e.g., a faceted orb) and other non-round structures such as an oblate or prolate structure or a cylindrical structure. It will be appreciated that the ball shape and the socket shape determine, at least in part, the possible directions of rotation of which the combined ball and socket apparatus is capable.

It will be appreciated that components of a stabilization apparatus, due to their attachment means and other structure, have an orientation that makes them function properly. Accordingly, such components have a front side, a back side, a top side and a bottom side. The term “upward” refers to the side of an object extending toward the head of a wearer, and the term “downward” refers to the side of an object extending toward the feet of a wearer. The term “inward” means toward a vertical plane extending through the center of the chest of the body of a wearer and dividing the wearer into a right half and left half. So, an inward direction from the notch of a shooter's right shoulder would mean in the direction of the left shoulder. The terms “left” and “right” refer to the right and left directions of a user/wearer of a stabilization system.

These and other aspects of the present invention will become apparent upon a review of the following detailed description and the claims appended thereto.

### BRIEF DESCRIPTION OF THE DRAWINGS

FIG. 1 is a cross sectional view of an example of a long gun stabilization kit comprising a vest clip and a butt attachment according to aspects of the present invention, the butt attachment connected to a butt end of a long gun stock;

FIG. 2A is a projection view of the vest clip of FIG. 1;

FIG. 2B is a plan view of the vest clip of FIG. 1;

FIG. 2C is a side view of the vest clip of FIG. 1;

FIG. 2D is a top, end view of the vest clip of FIG. 1;

FIG. 2E is a bottom, end view of the vest clip of FIG. 1;

FIG. 2F is a back view of the vest clip of FIG. 1;

FIG. 2G is a schematic illustration of a two piece, vest clip;

FIG. 3A is a schematic illustration of vest clip connected to a body armor vest;

FIGS. 3B and 3C are a front view schematic illustration and a side view schematic illustration of hard body armor typically contained within a vest as shown in FIG. 3A;

FIG. 4A is a projection view of the butt attachment of FIG. 1;

FIG. 4B is a cross section view of the butt attachment of FIG. 1 taken along section line 4B-4B of FIG. 4D;

FIG. 4C is a front view of the butt attachment of FIG. 1;

FIG. 4D is a back view of the butt attachment of FIG. 1;

FIGS. 4E-4G are schematic illustrations of another embodiment of butt stock attachment;

FIG. 5A is a projection view of yet another alternative embodiment of a butt attachment;

FIG. 5B is a cross section view of the butt attachment of FIG. 5A taken along section line 5B-5B of FIG. 5D;

FIG. 5C is a front view of the butt attachment of FIG. 5A;

FIG. 5D is a back view of the butt attachment of FIG. 5A;

FIG. 6 is a projection view of an assembly of the vest clip and the butt attachment of FIG. 1 attached to a stock of a long gun; and

FIG. 7 is a rear view, schematic illustration of a vest clip and gun combination according to aspects of the invention, showing an example of a boundary of a cone of discharge that is biased to an inward direction, assuming the vest clip is on a left shoulder of a shooter.

### DETAILED DESCRIPTION

Aspects of the invention will be further illustrated with reference to the following specific examples. It is understood that these examples are given by way of illustration and are not meant to limit the disclosure or the claims to follow to any specific embodiment.

Aspects of the invention are directed to a long gun stabilization kit and other aspects are directed to components of such a kit. Other aspects of the invention result from incorporating stabilization features into a long gun or into body armor.

Aspects directed to a long gun stabilization kit comprise a vest clip comprising a ball, and a butt portion having a socket to receive the ball. Aspects of the invention provide or facilitate long gun stabilization and one or more (and in some instances all) of the following: simple engagement and disengagement of the stabilization device (e.g., engagement using motion in a single direction), ergonomic viewing along the sight for aiming, ability to align the long gun in a full cone of discharge angles, and maintaining gun usability when not using body armor.

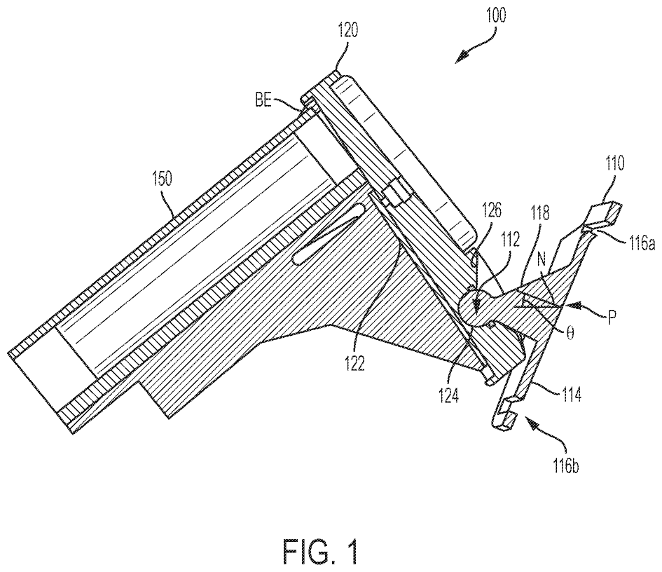

FIG. 1 is a cross sectional view of an example of a long gun stabilization kit 100 comprising a vest clip 110 and a butt attachment 120 according to aspects of the present invention. In FIG. 1, butt attachment 120 is connected to a butt end BE of a long gun stock 150 and vest clip 110 is shown apart from any vest.

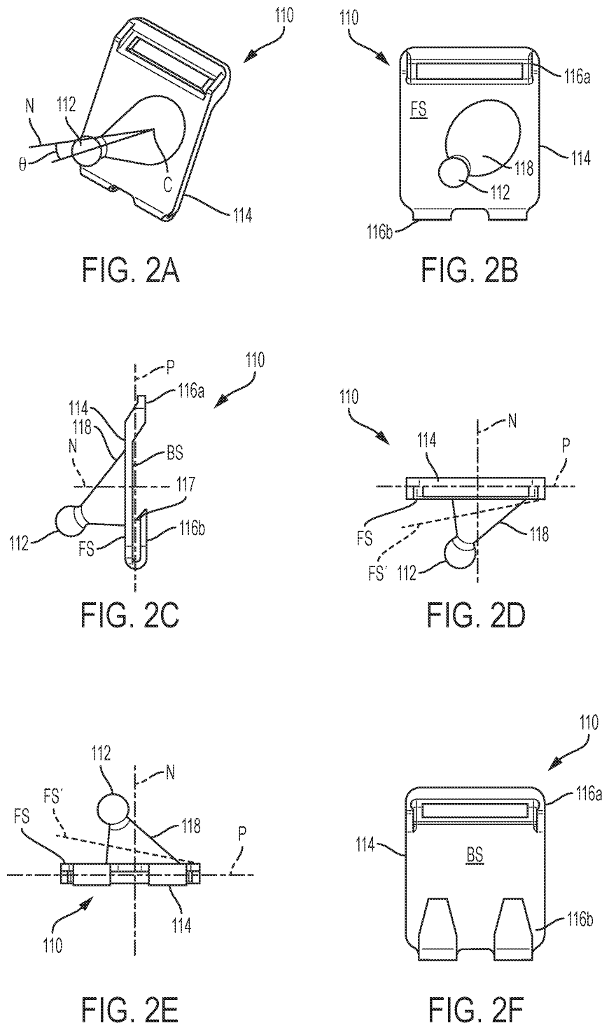

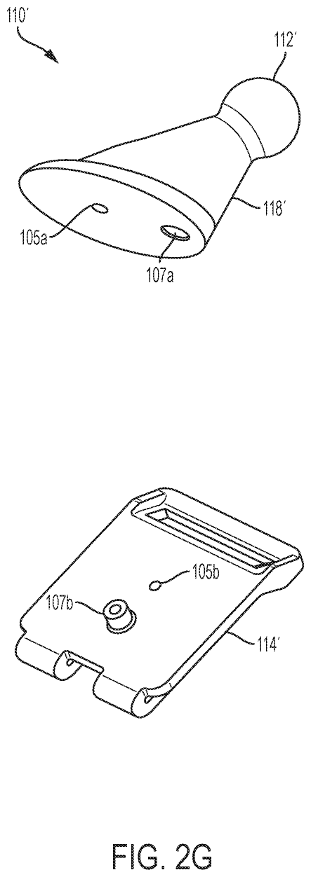

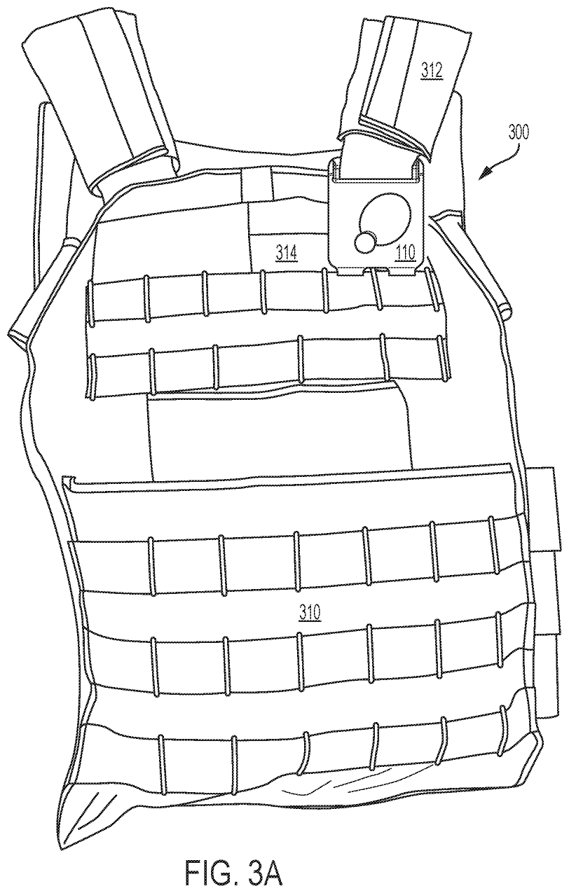

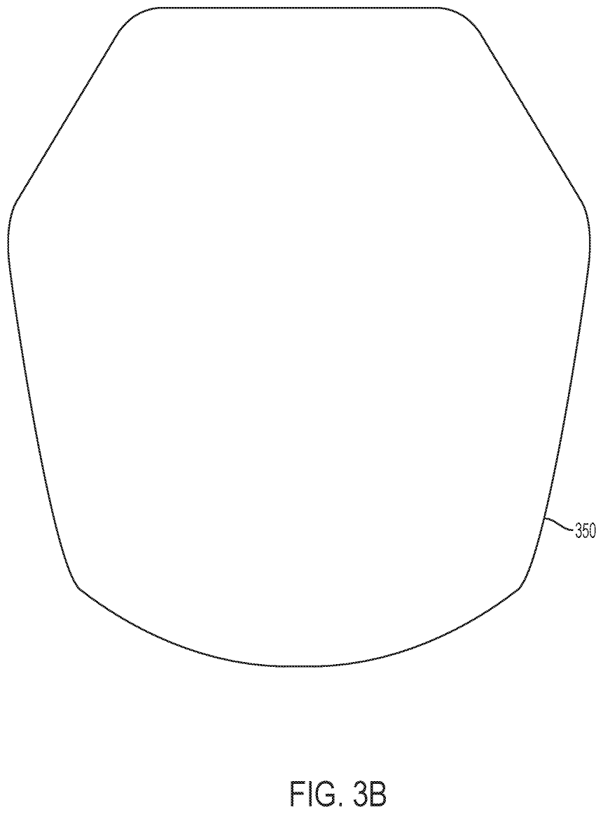

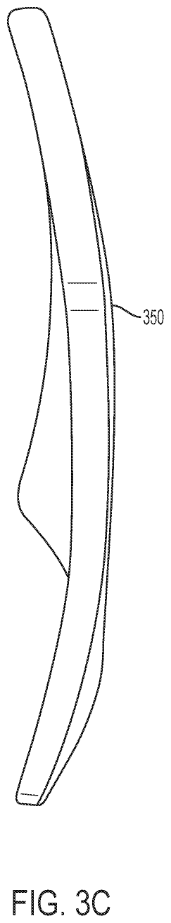

FIGS. 2A-2F show further details of example vest clip 110 according aspects of the invention. Vest clip 110 is now described with reference FIGS. 1 and 2A-2F. Vest clip 110 comprises a ball 112 and a clip body 114, and vest attachment means 116 for attaching vest clip 110 to a vest (shown in FIG. 3A). As set forth above, a ball can be, but need not be, a sphere. A ball has a curved outer surface that is configured to permit rotation within a socket about one or more axes. The clip body is a mass which directly or indirectly supports the remaining components of the vest clip.

Vest clip 110 is characterized by a vest interface plane P, the vest interface plane P having a normal N. Ball 112 is connected to the clip body by a projection 118 extending from clip body 114. Projection 118 extends (e.g., along a line through the center of the ball and the centroid C of the area where the projection attaches to the clip body 114) at an angle θ that is downward and left or right relative to normal N. Typically, a shooter would select a clip having a projection 118 that extends inward relative to normal N when attached to a vest (as shown in FIG. 3A). It will be appreciated that, to achieve an inward angle, a clip of appropriate construction is selected depending on which shoulder a clip is to be mounted. Typically, a right-handed shooter would mount a clip on his or her right shoulder, with projection 118 extending to the left. Projection 118 extends from a surface of the clip body that is generally opposite the vest interface plane P. In the illustrated embodiment, ball 112 is spherical, except where the ball is attached to projection 118.

FIG. 2G is a schematic illustration of a two piece, vest clip 110′. In the illustrated embodiment, a first piece comprises clip body 114′ and a second piece comprises ball 112′ and projection 118′. Vest clip 110′ is the same as vest clip 110, except for screw holes 105a, 105b, and orientation features 107a, 107b. For example, a two-piece configuration may improve manufacturability, in particular when the vest clip is molded. Additionally, since vest clips can be constructed with different ball and projection configurations (e.g., ball and projection configurations for right-handed and left-handed shooters), a two-piece construction can offer advantages in inventory control and usability in the field.

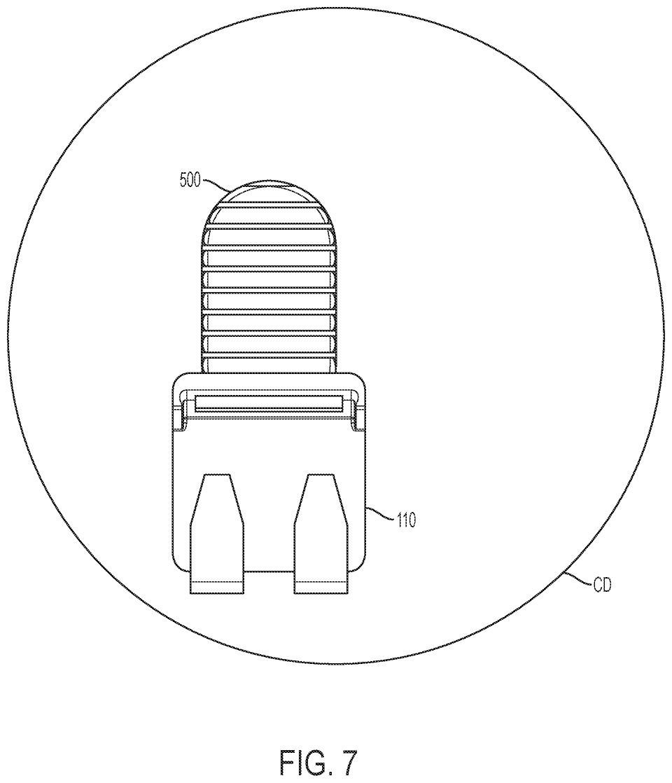

Projection 118, 118′ is connected to clip body at an angle that not parallel to normal N. The shape of the exterior of projection 118, 118′ is typically selected to avoid mechanical interference with features of the butt portion including socket 124 (shown in FIG. 1) as the ball rotates within the socket to achieve a desired cone of discharge CD (shown in FIG. 7). Projection 118 may have any suitable shape. For example, projection 118 may be cylindrical or conical or approximations thereof.

FIG. 3A is a schematic illustration of vest clip connected to a body armor vest. Further aspects of the invention are given below with reference to FIGS. 2A-2F and 3A.

Vest attachment means 116 comprises structure for attaching vest clip 110 to a vest, and can have a wide variety of different constructions. For example, the means 116 can be configured to connect with the vest using hooks and loops (e.g. Velcro®), a snap, a button, a pin, or by other mechanical interaction with the vest. As shown in FIGS. 2A-2F, one particularly useful configuration using mechanical interaction includes a strap hole 116a near a top end of clip body 114 through which a shoulder strap 312 of a vest extends and at least two hooks 116b that are separated from one another at the bottom end of the clip body. The hooks extend around straps 314 (also referred to as “webbing”) of a conventional Pouch Attachment Ladder System (PALS). As is conventionally understood, PALS may be included as a part of Modular Lightweight Load-carrying Equipment (MOLLE), which commonly includes a vest including body armor. It will be appreciated that such a configurations including hooks provides significant stability enhancement in each of the translational and rotation degrees of freedom of vest clip 110 when used with PALS. In some embodiments, hooks 116b, include a barb 117 to further secure the best clip 110 to the straps 314.

Vest interface plane P is disposed at locations along a back surface BS of vest clip 110 that contact an outer surface of a vest when the vest clip is attached to the vest by the vest attachment means. Locations on vest interface plane P orient the vest clip relative to the vest. Contact between back surface BS and a vest, typically, does not occur continuously along back surface BS due to the irregularity of the outer surface of the vest (e.g., the vest typically includes tactical nylon). In instances of a planar back surface BS, as shown in FIGS. 2A-2F, back surface BS and interface plane P are, typically, coincident.

Normal N is an axis extending normal to the vest interface plane P. Significantly, normal N may extend perpendicularly to a front surface FS of clip body 114 and a back surface BS of clip body 114 (e.g., if clip body is cuboid in shape—with the front surface FS of the clip body and the back surface BS of the clip body being parallel).

In some embodiments, it is advantageous if the front surface FS and the back surface BS are not parallel to one another (e.g., the clip body is wedge-shaped). A front surface FS' that is not parallel to back surface BS is shown with a dashed line in FIGS. 2D and 2E. As shown, in such embodiments, the back surface BS of the clip body contacts the vest along a plane generally parallel to the front of the vest (similar to the embodiment having a cuboid clip body, discussed above); however, front surface FS' of the clip body extends at an angle relative to the front of the vest. It is to be appreciated that, in embodiments where front surface FS' and back surface BS are not parallel to one another, projection 118 still extends from clip body 114 at an angle θ that is downward and inward relative to normal N.

As set forth above, vest clips according to aspects of the present invention do not have balls disposed on projections extending normally to vest interface plane P, which is in contrast to conventional vest clips; instead, according to aspects of the present invention, balls are disposed on projections that extend downward and inward relative to vest interface plane P. As determined by the inventors, the downward orientation of the projection is an example of an aspect of the invention that contributes to relatively simple engagement and disengagement of the long gun stabilization device (e.g., embodiments of the invention provide engagement using motion in a single direction). It will be appreciated than a shooter typically brings a gun from a position lower that the vest clip into a shooting position. Accordingly, as determined by the inventors, movement of the long gun into engagement with a ball disposed on a projection extending downward provides for engagement of the ball and socket by movement of the socket directly toward the ball (i.e., in a single direction).

It will be appreciated that a shooter typically brings a gun from a location proximate the vertical plane dividing a body into a left side and a right side, toward a shoulder. Accordingly, a ball on an inwardly extending projection allows a shooter to use a more natural motion when engaging the ball and socket, as the shooter orients the gun to view along the barrel of the long gun. Furthermore, after engagement of the ball and socket, a ball disposed on a projection that extends inward relative to vest interface plane P contributes to ergonomic viewing along the gun's sight, as compared to a ball disposed on projection extending normal to the vest interface plane.

It will be appreciated that vest clips for right-handed shooters and vest clips for left handed shooters both have projections that extend downward relative to vest interface plane P; however, they extend toward different sides of the clip body (i.e., vest clip for a right-handed shooter has a projection that extends toward the left side of the clip body, and vest clip for a left-handed shooter has a projection that extends toward the right side of the clip body.

Another aspect of the invention is directed to body armor 300 comprising a vest 310; and vest clip 110 connected to the vest. As described above, means 116 can be configured to connect with the vest using hooks and loops (e.g. Velcro®), a snap, a button, a pin, or by other mechanical interaction with the vest.

It is to be understood that aspects of the invention are directed to a vest clip having a projection extending from the clip body at an angle that is downward and inward relative to the normal; however according to further aspects of the invention, it is advantageous that projection 118 extends in a downward and inward direction as worn by a shooter wearing body armor including the vest. That is, if a tangent plane were drawn at the center of the exterior of the wearer's chest, projection 118 would extend, both, inward and downward relative to normal to the tangent plane. To that end, it will be appreciated that, as shown in FIG. 3A, vest 310 provides a surface that is not perfectly smooth (e.g., due to the presence of tactical nylon disposed on the exterior of the vest), and hard body armor 350 that is present inside the vest (shown in FIGS. 3B-3C) may have a curvature approximating the curvature of the chest. It will be understood that the hard body armor is positioned in the vest such that a force applied to the ball in direction of the clip body is resisted by the hard body armor.

In some embodiments, given the presence of vest 310 and the hard body armor 350 and variations in surfaces angles associated therewith, the angle θ that projection 118 makes with vest interface plane P (such that projection 118 extends in a downward and inward direction relative to the tangent plane) is typically a downward angle in the range 20 to 30 degrees (e.g., 25 degrees) and an inward angle in the range 15 to 25 degrees (e.g., 22 degrees).

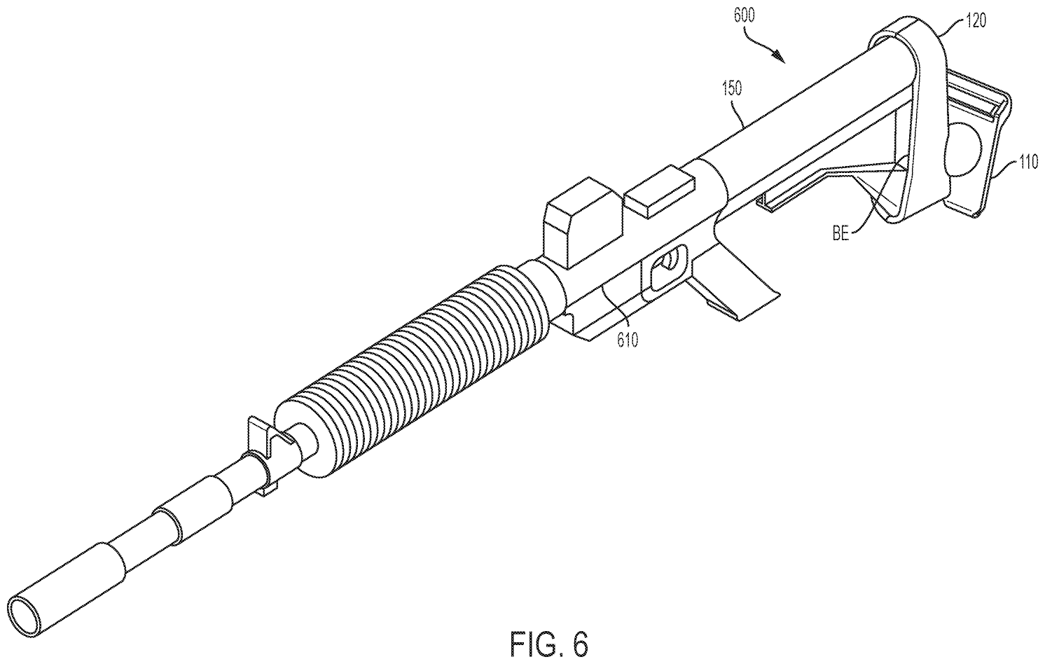

Now, turning to butt stock portion 120 of long gun stabilization kit 100, it is noted that butt portion 120 can be embodied in many forms. For example, the butt portion may be a butt stock attachment (as shown in FIG. 1 and FIGS. 4A-4D or FIGS. 5A-5D) having structure to attach to a butt stock or it may be a butt stock (e.g., a butt stock replacement for a gun as shown in FIG. 6, the replacement being attachable to a back end of a gun) having a socket formed therein or a butt portion formed integrally with a gun (i.e., the gun and stock may be of unitary construction with the butt stock not being separatable from the remainder of the gun).

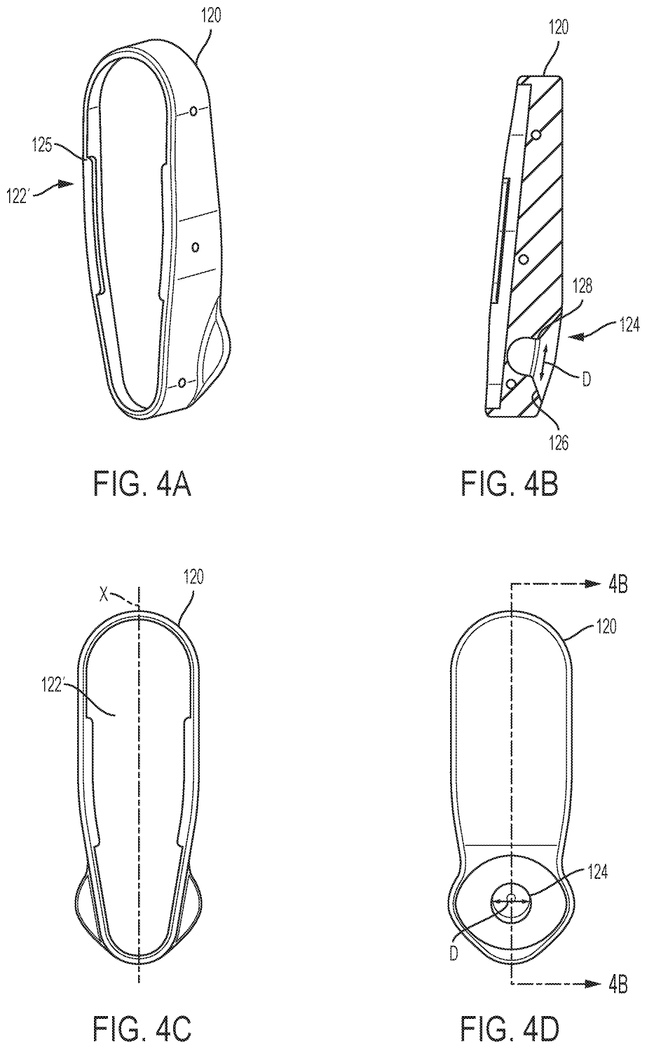

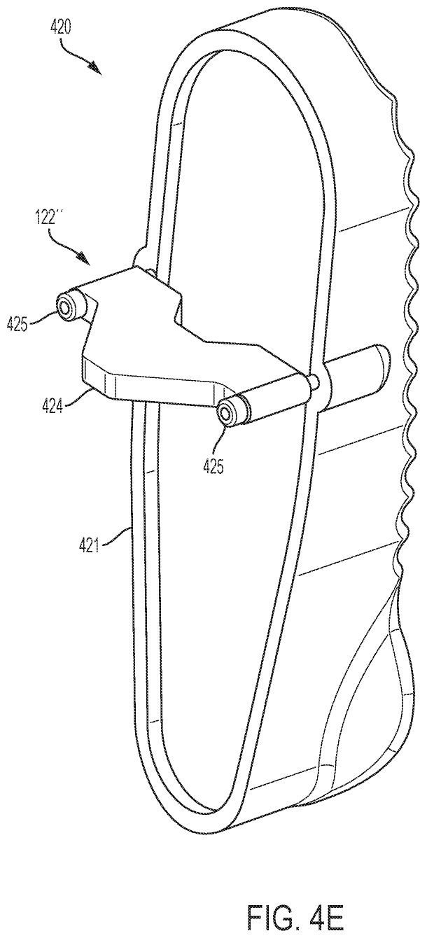

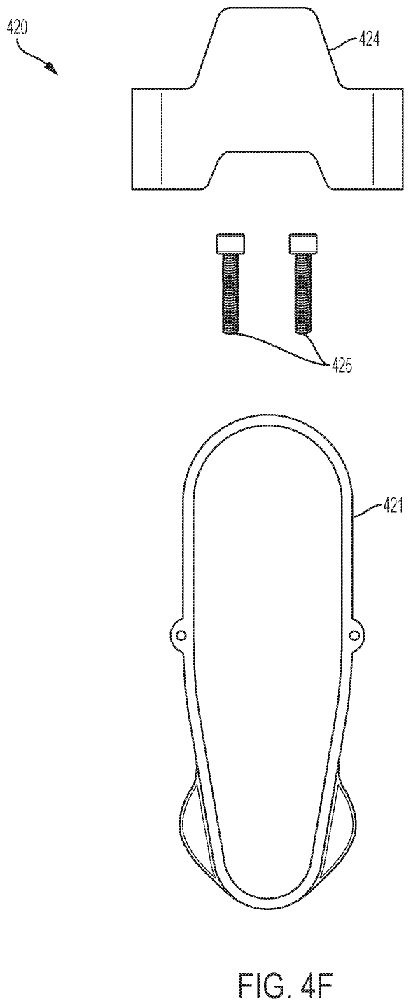

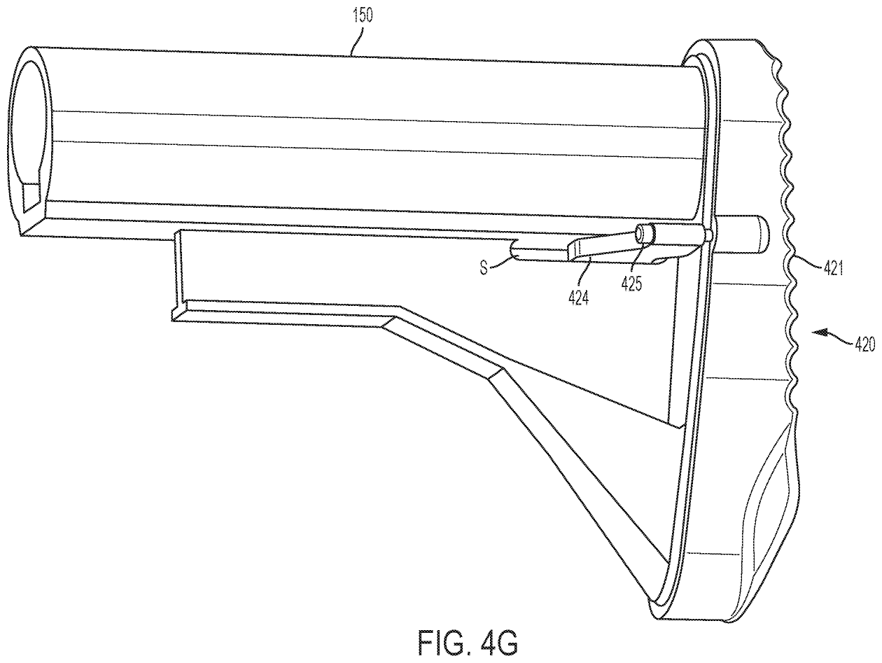

FIGS. 4A-4D show further details of the example butt stock portion according aspects of the invention in which the butt stock portion is embodied as a butt attachment 120. Butt attachment 120 is described below with reference FIGS. 1 and 4A-4D.

Butt portion 120 has a socket 124 of fixed geometry to receive ball 112. In some embodiments, the socket has a spherical shape (with a fixed diameter D) formed along an interior surface of the butt portion, for engagement with the ball such that the ball slides along the interior surface. For use with such embodiments, a spherical ball 112 may be used. As mentioned above, the ball may be non-spherical. For use with such non-spherical balls, the socket has a corresponding surface such that the ball may rotate along a surface of the socket in one or more directions (i.e., about one or more axes). The circumference of the opening to the socket may be circular or another shape.

A fixed geometry (e.g., for a spherical socket a socket having a fixed, non-adjustable diameter) provides for relatively simple engagement and disengagement of the stabilization device (e.g., the ball is brought into engagement with the socket and the socket need not be adjusted (e.g., clamped) to receive and/or maintain the ball therein).

In some embodiments, butt portion 120 is provided with a guide 126 to direct ball 112 into socket 124. The guide has sloped surfaces providing wider opening than the socket that leads to the socket. The slope surface may be circumferentially continuous so as to form a conical shape to funnel a ball into the socket. A ring 128 that is slightly narrower than the opening into the socket may be provided, such that upon insertion of ball 112 into the socket, ball 112 provides an audible indication and/or provides tactile feedback to the user so as to provide surety that the ball and socket are properly connected.

It will be appreciated that the socket of fixed geometry and ball provide for relatively simple engagement and disengagement of the stabilization device (e.g., engagement using motion in a single direction) since the ball can be brought into engagement with the socket from many different angles each requiring movement in only a single direction (i.e., motion bringing the gun (including the socket) directly toward the ball on the vest clip).

A butt attachment has means for attaching to a long gun stock. The means may take many different forms. FIGS. 4A and 4C illustrate one particularly advantageous means of attachment 122′. Attachment 122′ comprises a lip 125 which is positionable around a plate at the butt end of the stock by flexing the butt attachment to widen the opening between lips 125 and releasing the flexed butt attachment such that the lip attain a relaxed shape with the lips extending around the plate. For example, a butt attachment may be made of a rigid plastic and manufactured using suitable molding techniques; in such embodiments, it may be desirable to mold the butt attachment as two separate halves (e.g. separated along line X shown in FIG. 4C), and to attach the halved together, for example, using a one or more bolts (not shown).

FIGS. 4E-4G are schematic illustrations of another embodiment of butt stock portion, embodied as a butt stock attachment 420. Butt stock attachment 420 is configured and operates in a manner similar to butt stock attachment 120 (shown in FIGS. 4A-4D) except that means of attachment 122″ includes a brace 424 or other connector for wrapping around a portion of a butt stock. In the illustrated embodiment, two bolts 425 constrict brace 424 and the butt stock body 421 together, thereby securing butt stock attachment 420 to the butt stock 150 using threaded holes. As shown in FIG. 4G, the brace can be configured to extend through a slot S of a conventional replacement butt stock.

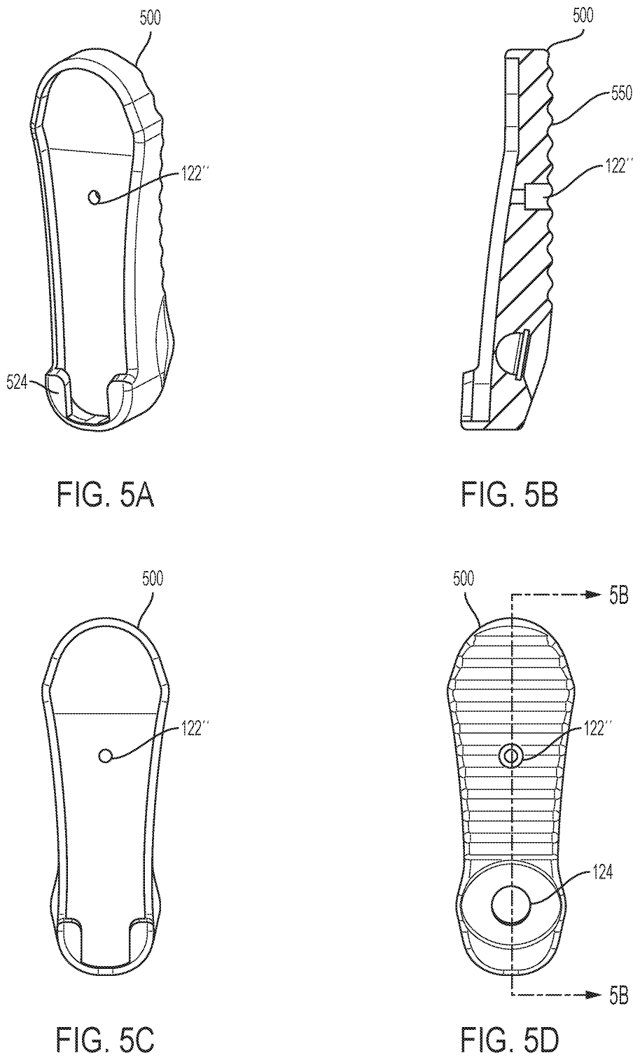

FIGS. 5A-5D show an alternative embodiment of a butt stock portion according aspects of the invention in which the butt stock portion is embodied as a butt attachment 500. Butt stock portion 500 includes a socket 124 of fixed geometry to receive ball 112 as described above with reference to FIGS. 4A-4D. However, the means of attachment comprises a screw hole 122″ which permits attachment to a butt end of a stock using a screw. Such a means of attachment is useful for attachment to a Magpul® Stock available from Magpul Industries. One or more lips 524 may be added to improve stability relative the butt stock portion. Texturing 550 may be added to reduce sliding along a vest in the absence of a vest clip.

FIG. 6 is a projection view of a long gun 600 having butt portion 120 (as described above with reference to FIG. 1). Long gun 600 comprises a barrel 610, a stock 150 having butt end BE, and a butt attachment 120 connected to stock 150 at butt end BE. Butt attachment 120 has a socket 124 having fixed geometry located on butt end BE (shown in FIGS. 4B and 4D, and FIGS. 5B and 5D).

Although the embodiment of the long gun in FIG. 6 includes a butt attachment, it is to be understood that, in other embodiments, a butt portion of another configuration may include socket 124. For example, as described above, a separate stock (e.g., a replacement stock) may have the socket integrally formed therein, the stock being attached to long gun 600. Alternatively, in embodiments where the stock is integrally formed with a remainder of the gun, the gun may have the socket integrally formed in the stock.

FIG. 7 is a schematic illustration of a review view of a vest clip and gun combination 700, showing an example of a boundary of a cone of discharge CD that is possible using aspects of the invention. Referring to FIGS. 1 and 7 it is apparent that, by limiting the material present in projection 118 and by providing a sufficiently large opening to socket 124, ball 112 freely rotates within socket 124 to achieve a relatively large cone of discharge CD. Additional design aspects contributing to a large cone of discharge include, for example the length of projection 118, the angle of the slope of the walls of guide 126, the placement of the socket near a bottom end of butt end BE. Due to projection 118 extending inward relative to the normal N of vest interface plane P, the cone of discharge is advantageously biased in the inward direction. Such a bias provides ergonomic advantages and more, useful shooting angles within the cone of discharge CD than if projection 118 were extended perpendicularly to vest interface plane P, because shooters tend to have more opportunities to shoot in the inward directions (e.g., around a corner of building) than outward directions.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

### LIST OF REFERENCE NUMBERS

100—long gun stabilization kit
105a, 105b screw holes
107a, 107b orientation features
110—vest clip
112—ball
114—clip body
116—vest attachment means
117—barb
118—projection
120—butt attachment
122—means for attaching to a long gun stock butt
124—socket
125—lip
126—guide
128—ring
150—long gun stock
300—body armor
310—body armor vest
312—shoulder strap
314—straps
350—hard body armor
420—butt stock attachment
422—means of attachment to a long gun stock butt, alternative embodiment
424—brace
424—bolts
500—butt attachment, alternative embodiment
524—lips, alternative embodiment
550—texture
600—long gun
610—long gun barrel
BE—butt end of long gun stock 150
BS—back surface of vest clip 110
D—socket diameter
FS—front surface of vest clip 110
P—vest interface plane
N—normal
S—slot
θ—angle

What is claimed:

1. A long gun stabilization kit for use with a body armor vest, comprising:
a vest clip comprising a clip body and a ball, and having vest attachment means for attaching to the body armor vest, the vest clip being characterized by a vest interface plane having a normal, the ball connected to the clip body by a projection extending from the clip body at an angle that is downward, and left or right relative to the normal; and
a butt end portion having a socket shaped to receive the ball and permit rotation about at least one axis.

2. The kit of claim 1, wherein the butt end portion constitutes a portion of a butt stock.

3. The kit of claim 1, wherein the ball is spherical.

4. The kit of claim 1, wherein the vest attachment means comprises an eyelet for receiving a shoulder strap of the body armor vest disposed at a top end of the clip body and at least two hooks at a bottom end of the clip body.

5. The kit of claim 1, wherein the clip body is cuboid.

6. The kit of claim 1, wherein clip body is configured such that a front surface of the clip body is not parallel to a back surface of the clip body.

7. The kit of claim 1, wherein the angle has a downward component in the range 20 and 30 degrees, and a left or right component in the range 15 and 25 degrees.

8. The kit of claim 1, wherein the butt end portion constitutes a portion of a butt stock attachment.

9. The kit of claim 8, wherein the butt stock attachment comprises a lip configured to be positionable around an end plate of a butt end of a gun to maintain a connection with the butt end.

10. The kit of claim 8, wherein the butt stock attachment comprises a screw hole configured allow attachment of the butt stock attachment to a gun stock.

11. The kit of claim 1, wherein the butt end portion constitutes a portion of a butt stock.

12. The kit of claim 1 wherein the butt end portion is integrally formed with a remainder of a gun.

13. The kit of claim 1, wherein the socket is spherical in shape.

14. The kit of claim 3, wherein the socket is spherical in shape.

15. The kit of claim 1, wherein the butt end portion has a guide having sides sloped to funnel objects into the socket.

16. A vest clip for stabilizing a long gun, comprising a clip body and a ball, and having vest attachment means for attaching to a body armor vest, the vest clip characterized by a vest interface plane having a normal, the ball connected to the clip body by a projection extending from the clip body at an angle that is downward, and left or right relative to the normal.

17. The vest clip of claim 16, wherein the vest attachment means comprises an eyelet for receiving a shoulder strap of the body armor vest disposed at a top end of the clip body and at least two hooks at a bottom end of the clip body.

18. The vest clip of claim 16, wherein the clip body is cuboid.

19. The vest clip of claim 16, wherein clip body is configured such that a front surface of the clip body is not parallel to a back surface of the clip body.

20. The vest clip of claim 16, wherein the angle has a downward component in the range 20 and 30 degrees, and a left or right component in the range 15 and 25 degrees.

21. Body armor, comprising:
a body armor vest; and
a vest clip connected to the body armor vest, the vest clip comprising a clip body and a ball, the vest clip characterized by a vest interface plane having a normal, the ball connected to the clip body by a projection extending from the clip body at an angle that is downward, and left or right relative to the normal.

22. The body armor of claim 21, wherein the body armor vest includes hard body armor positioned such that a force applied to the ball in direction of the clip body is resisted by the hard body armor.

23. The body armor of claim 21, wherein the clip body is cuboid.

24. The body armor of claim 21, wherein clip body is configured such that a front surface of the clip body is not parallel to a back surface of the clip body.

25. The body armor of claim 21, wherein the angle has a downward component in the range 20 and 30 degrees, and a left or right component in the range 15 and 25 degrees.

26. A butt attachment, comprising:
a body of the butt end attachment having a socket of fixed geometry; and
means for attaching the body to a long gun stock butt end.

27. The butt attachment of claim 26, further comprising a guide having sides sloped to funnel objects into the socket.

28. The butt attachment of claim 26, wherein the means for attaching comprises a lip configured to be positionable around an end plate of a butt end of a gun.

29. The butt attachment of claim 26, wherein the means for attaching comprises a screw hole configured allow attachment of the butt stock attachment to a gun stock.

30. The butt attachment of claim 26, wherein the socket is spherical in shape.

31. The butt attachment of claim 26, wherein the butt end attachment body comprises a guide having a sloped to funnel objects into the socket.

32. A long gun, comprising:
a barrel;
a stock having a butt end, a portion of the butt end having a socket of fixed geometry.

33. The long gun of claim 32, wherein the socket is spherical in shape.

34. The long gun of claim 32, wherein the butt end portion comprising a guide having sides sloped to funnel objects into the socket.

35. The long gun of claim 32, wherein the socket is located on a bottom end of the butt end.

36. A gun stock comprising a butt end having a socket of fixed geometry located on the butt end.

37. The gun stock of claim 36, wherein the gun stock is attachable to a remainder of a gun.

38. The gun stock of claim 36, wherein the socket is spherical in shape.

39. The gun stock of claim 36, wherein the butt end portion has a guide having sides sloped to funnel objects into the socket.

40. The gun stock of claim 36, wherein the socket is located on a bottom end of the butt end.
